(19) United States
(12) Patent Application Publication
(10) Pub. No.: US 2015/0261236 A1
(43) Pub. Date: Sep. 17, 2015

(54) Method for Identification of Energy Saving Opportunities

(71) Applicant: GM GLOBAL TECHNOLOGY OPERATIONS LLC, Detroit, MI (US)

(72) Inventors: Guoxian Xiao, Troy, MI (US); Jorge F. Arinez, Rochester Hills, MI (US); Seog-Chan Oh, Royal Oak, MI (US); Robert Baird, JR., Clarkston, MI (US); Alfred Hildreth, Rochester Hills, MI (US); Timothy Stork, Westland, MI (US)

(73) Assignee: GM GLOBAL TECHNOLOGY OPERATIONS LLC, Detroit, MI (US)

(21) Appl. No.: 14/207,805

(22) Filed: Mar. 13, 2014

(51) Int. Cl. G05F 1/66

(52) U.S. Cl. CPC G05F 1/66

(57) ABSTRACT

Provided is a system and a method for identifying inefficiency of energy utilization in a facility by using actual past consumption data. The method uses the past energy usage data, weather information, production information, and variables estimated using Stochastic Frontier equation to calculate energy inefficiency for a production facility.

### FIELD OF THE PRESENT TECHNOLOGY

The present technology relates generally to electric energy consumption. More specifically, the present technology relates to identifying opportunities to improve efficiency in electric energy consumption in a manufacturing facility.

### BACKGROUND OF THE PRESENT TECHNOLOGY

The energy consumption in a manufacturing plant represents a major component of manufacturing cost and affects the overall cost and price for each product. It is thus important to reduce energy consumption in the manufacturing plant.

It is not easy to reduce the energy consumption in a large manufacturing plant, such as a production plant for automobile manufacturing. Because a variety of manufacturing activities are performed in the production plant, it is difficult to identify locations where the energy is not being used efficiently. Additionally, if one simply measures consumption of electricity by a particular manufacturing activity, it would be hard to determine whether the electricity consumed is what is required for the manufacturing activity or not.

Without knowing how much electricity is consumed in each location or by each manufacturing activity and whether the consumption is normal for this activity, it is impossible to identify the opportunities to improve the electricity usage. The present technology is directed primarily to a system and method that identifies opportunities to improve electricity consumption in a manufacturing facility.

### SUMMARY OF EMBODIMENTS OF THE TECHNOLOGY

Given the aforementioned deficiencies, a need exists for methods and systems to better identify energy usage inefficiency in a production facility. More specifically, methods and systems are needed to identify energy usage inefficiency in a production facility using past energy usage data.

In one embodiment, the present technology is a system, for calculating energy usage efficiency in a facility, comprising a processor and a memory system for storing computer-executable program code, which when executed by the processor, causes the processor to perform operations comprising obtaining past energy usage data from a secondary memory, obtaining past production data from the secondary memory, obtaining weather information from a weather-monitoring system, such as a computing device of a weather monitoring center, estimating a plurality of variables based on the past energy usage data for a sliding time window, and calculating the energy usage efficiency.

In another embodiment, the present technology is a method, for measuring energy usage efficiency in a facility, comprising obtaining, from a secondary memory, by a system using a processor, past energy usage data, obtaining, by the system, from the second memory, past production data, obtaining, by way of an external interface unit, from a weather-monitoring system, weather information, estimating, by the system, a plurality of variables based on the past energy usage data for a sliding time window, and calculating, by the system, the energy usage efficiency for the sliding time window.

In yet another embodiment, the present technology is a tangible computer-readable storage device comprising computer-executable code that, when executed by a processor, causes the processor to perform operations, for measuring energy usage efficiency in a facility, comprising, obtaining, from a secondary memory, past energy usage data, obtaining, from the secondary memory, past production data, obtaining, from a weather-monitoring system, weather information, estimating a plurality of variables based on the past energy usage data for a sliding time window, and calculating the energy usage efficiency.

Further features and advantages of the technology, as well as the structure and operation of various embodiments of the technology, are described in detail below with reference to the accompanying drawings. It is noted that the technology is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form part of the specification, illustrate the present technology and, together with the description, further serve to explain the principles of the technology and to enable a person skilled in the relevant art(s) to make and use the technology.

FIG. 1 is an illustration 100 illustrating difficulties in measuring energy consumption per products produced.

FIG. 2 is an illustration 300 for dividing a space according to one embodiment of the present technology.

FIG. 3 is a chart 200 illustrating measured energy consumption by zones.

FIG. 4 is a chart 400 illustrating energy consumption measured on the divided space.

FIG. 5 is architecture 500 of a computing device supporting the present technology.

### DETAILED DESCRIPTION OF EMBODIMENTS OF THE TECHNOLOGY

While the present technology is described herein with illustrative embodiments for particular applications, it should be understood that the technology is not limited thereto. Those skilled in the art with access to the teachings provided herein will recognize additional modifications, applications, and embodiments within the scope thereof and additional fields in which the technology would be of significant utility.

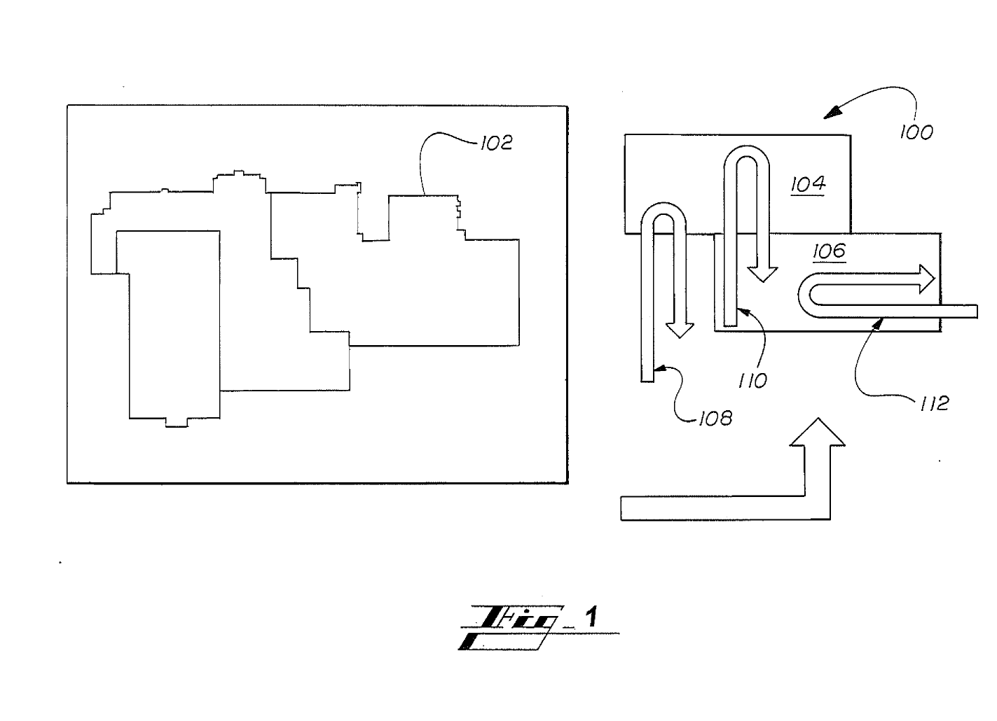

FIG. 1 is a drawing 100 showing aspects of energy measuring functions in connection with a production facility 102. The production facility 102 is generally arranged to make production easier and may not be designed with energy measurement in mind. The production facility 102 may be divided into separated areas with production lines distributed in these areas. A production line may be entirely contained within an area, such as production line 112 contained in Area 106, as shown in FIG. 1. A production line may also spread into multiple areas, such as production line 110 flowing through Area 104 and Area 106. Finally, a production line 108 may be processed only in a small part of an area, such as production line 1 in Area 104.

Conventionally, a separate energy measuring device placed is not pleased in the separate parts of the production facility 102; rather, usually only one or very few energy measuring devices are used in a production facility 102. It is thus traditionally difficult to measure energy consumption in the production facility and very difficult to identify locations where energy usage is most inefficient.

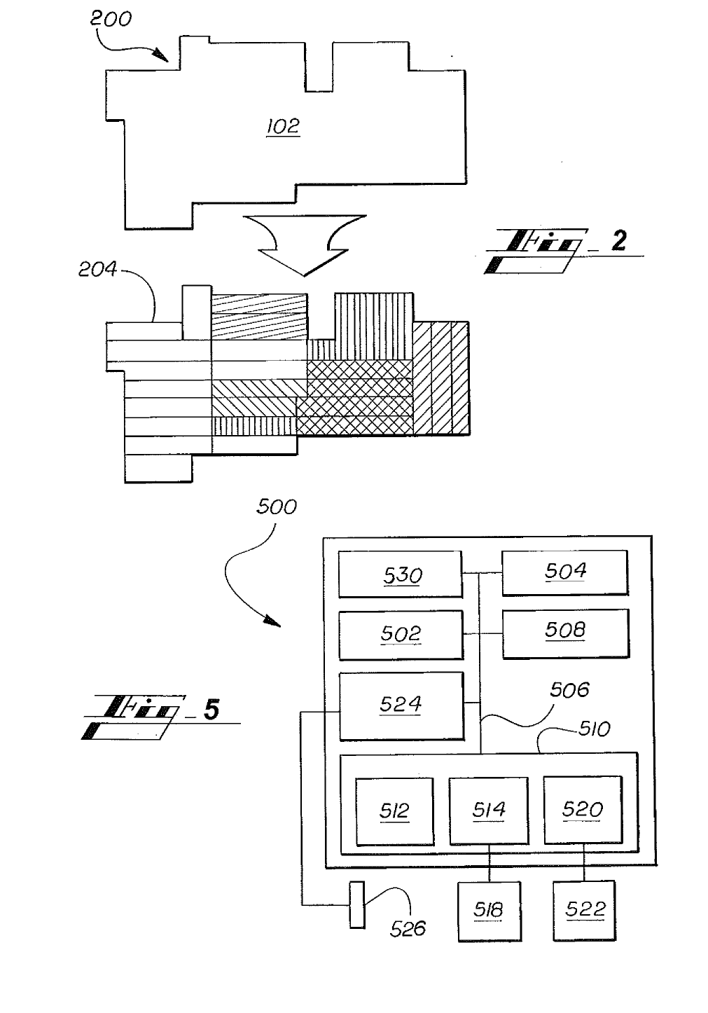

One way to improve the understanding of energy consumption in the production facility is to divide the facility into smaller zones and install an energy measuring device in each zone. FIG. 2 illustrates the production facility 102 in FIG. 1 divided into several small zones 204. The division may be based on the production flow or distribution of production machines. For each zone, an energy measuring device is installed. Alternatively, several zones may share one energy measuring device.

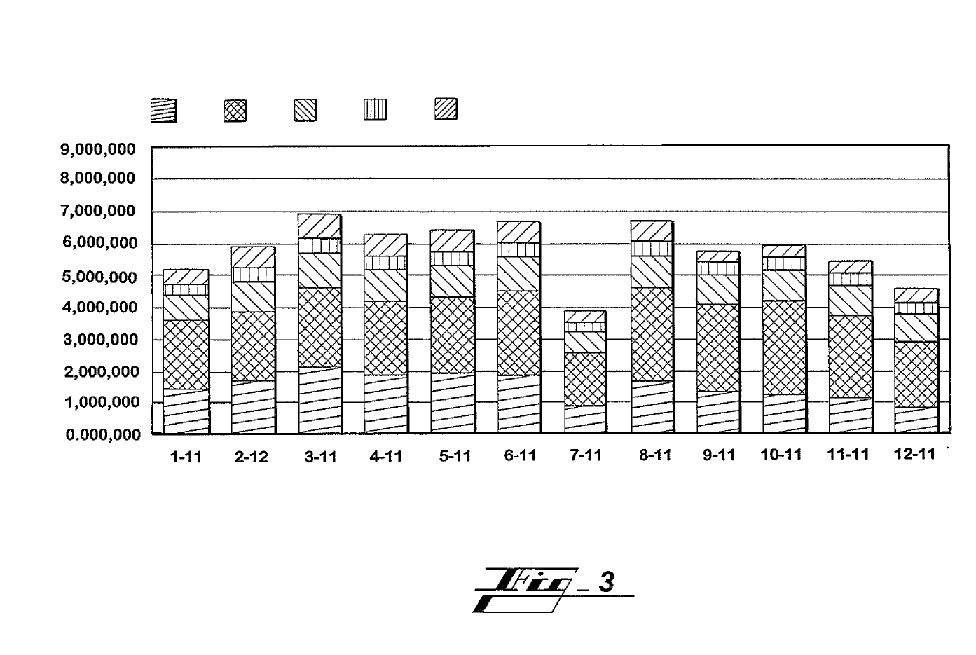

FIG. 3 is a chart of measurements taken in connection with several zones during one calendar year. The X-axis represents the date of measurement and Y-axis represents the energy consumed in KWh. As shown in the figure, the chart provides the information on the energy consumption by zones or groups of zones for each time period, but there is no information regarding whether the energy consumption in each zone is efficient or not. For example, the first column labeled as 1-11 in the chart reflects the total energy usage measure on January 11 for several groups of zones; each group of zones is represented by a different shading. The shading corresponds to the shading used in FIG. 2 to represent different zones. By comparing the first column (1-11) with the second column (2-12), it is noted that the total energy consumption is increased and it can be observed the increase in each group of zones. For example, for the group of zones on the lowest part of the first and second columns, the energy consumption measured on January 11 is approximately 1,500,000 KWh and energy consumption measured on February 12 is approximately 1,8000,000 KWh. The increase is observed but it is unclear the reason of the increase is due to the weather, the production, or increase in inefficiency.

To understand whether the energy usage is efficient or not and to identify possible opportunities for improvement on energy usage, the following mathematical model for energy performance is devised.

E/Y=f(External factors)+G(Alternative factors)+U+V Equation 1

### Where:

E=Energy Consumed in Total Operation
Y=Number of Units Produced.
External (Environmental) Factors: Heating/Cooling/Humidity etc.
Alternative Factors: Production utilization, technology application, etc.
U=Non-negative variables to account for energy inefficiency. Assumed to be |N(0, σᵤ²)|.
V=Random variable assumed to be N(0, σᵥ²).

Equation 1 is devised following the model for Stochastic Frontier Analysis (SFA) and the core objective of the mathematical model and of equation 1 is to find U, which follows a half-normal distribution.

When equation is applied to the production facility as illustrated in FIG. 2, equation 2 based on an improved Stochastic Frontier Analysis (SFA) is devised and shown below.

Eᵢ/Yᵢ=β₀+β₁*HDDᵢ+β₂*HDDᵢ²+β₃*CDDᵢ+β₄*CDDᵢ²+β₅*Capacity_Utilizationᵢ+Uᵢ+Vᵢ Equation 2

### Subject to

ΣEᵢ=E & ρUᵢ=U for all i

### Where:

Eᵢ=Energy Consumed in Zone i
Yᵢ=Number of Units Produced in Zone i
HDDᵢ=Heating Degree Days (obtained from local weather monitoring centers)
CDDᵢ=Cooling Degree Days (obtained from local weather monitoring centers)
Capacity_Utilizationᵢ=variable representing alternative factors, such as production level
Uᵢ=Non-negative variables to account for energy inefficiency. Assumed to be |N(0, σᵤ²)|
Vᵢ=Random variable assumed to be N(0, σᵥ²)

Uᵢin equation 2 is an indicator of energy inefficiency and equation 3 is derived from equation 2 and calculates for Uᵢ.

Uᵢ=(Eᵢ/Yᵢ)−(β₀+β₁*HDDᵢ+β₂*HDDᵢ²+β₃*CDDᵢ+β₄*CDDᵢ²+β₅*Capacity_Utilizationᵢ+Vᵢ) Equation 3

β₀, β₁, and β₂ are the parameters used to calculate the impact of each variable on energy intensity. The impact of each variable needs to be calculated and normalized, so that the best practice level in energy use is not subject to any specific variable setting, thereby being able to conduct an objective comparison between the actual energy usage and the best practice. There may be multiple βs for each zone and one β is estimated for each variable in the equation 2 or equation 3. For the present invention five βs are estimated for each zone since there are five variables.

βs are estimated based on past energy consumption data from a sliding time window that covers one year of energy consumption data (such as energy consumption per product, heating degree days, cooling degree days, humidity days, production capacity, and/or per other factors). The βs are unique to the sliding time window because they are derived based on the energy consumption data for that particular window. So, the β for the sliding time window that covers from Jan. 1, 2013, to Dec. 31, 2014, will be different from the β for the sliding time window that covers from Feb. 1, 2013, to Jan. 31, 2014. The βs are derived by a special statistical method called Stochastic Frontier Analysis. In brief, first, they are estimated by Linear Regression Method, which will find their initial value (such as average values), then using maximum likelihood to find out their Frontier values. If βs Frontier values are found, the equation 2 can calculate the minimum energy consumption for each product (engine or vehicle). After calculating the minimum energy consumption value, the real measurement energy values minus the minimum energy consumption will yield inefficiency.

Now, applying the equation 2 with data taken from the last year (one year sliding time window), it can be identified inefficiency in energy usage in any particular zone in the production facility and over any particular time period within the last year. By checking the data from the last year, the energy consumed in any particular zone (Eᵢ) can be obtained, as well as the number of units produced by that zone (Yᵢ) and the production level (Capacity_Utilizationᵢ). The number of heating degree days (HDDᵢ) and cooling degree days (CDDᵢ) for that particular period can be obtained from a weather-monitoring system, such as a computing device of a local weather monitoring station or from a local weather information center. The beta (β) values are estimated from the last year energy consumption data according to Stochastic Frontier function. With these values in equation 3, the inefficiency for each zone can be identified.

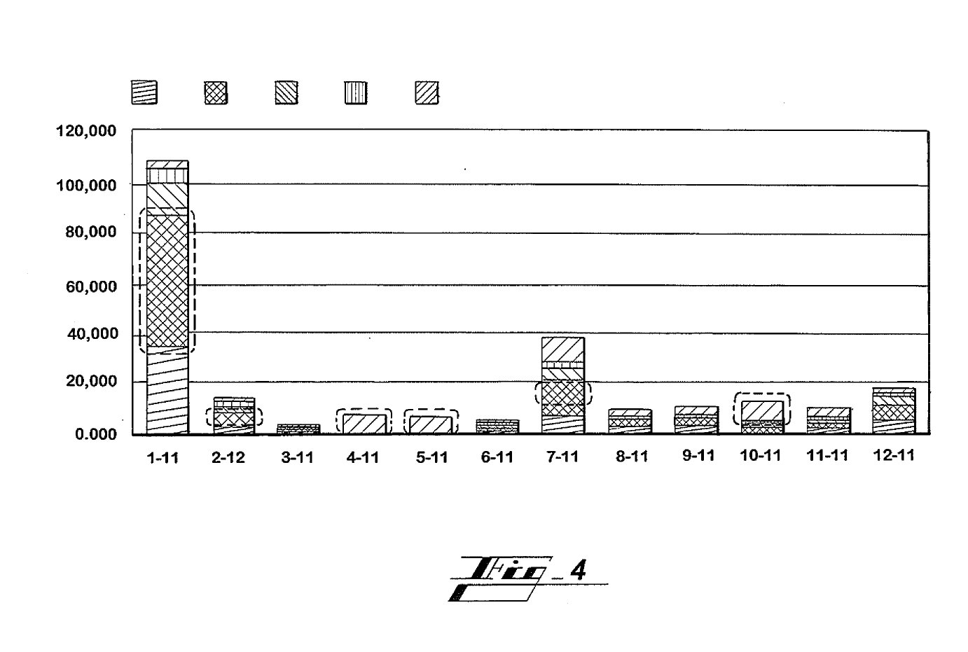

FIG. 4 is a graphic representation of identified zone-based inefficiency. The X-axis represents the date of measurement and Y-axis represents the energy consumed in KWh. For example, for the period ending on January 11, the zone encircled by the dashed line shows the most inefficiency. The box represented by dashed line in the column for Jan-11 represents the amount of energy consumed for producing a certain number of units. The size of the dashed line box represents the inefficiency in the production. The energy usage inefficiency identified is for the sliding time window.

Various aspects of the present technology may be implemented in software, firmware, hardware, or a combination thereof. FIG. 5 is an illustration of an example computer system 500 supporting the present technology. For example, equations 2 and 3 may be implemented by the computer system 500.

Computer system 500 includes a display unit 530, a display interface unit 502, a communication interface 524, a processor 504, a main storage unit 508, and a secondary storage unit 510. The display unit 530 is controlled by the display interface unit 530 and displays results of the inefficiency calculation, such as the graphic shown in FIG. 4, to users.

The communications interface unit 524 interfaces, by way of the communications path 526, with external systems (not shown in detail) to obtain information such as CDDs and HDDs. The communications interface unit 524 may also connect, by way of the communications path 526, to external energy measuring devices installed in each zone in a production facility.

The measurement of energy usage from each energy usage measuring device can be read, recorded, and stored by the system 500. The past energy consumption data is stored in the secondary memory 510, which may include hard disk drive 512, removable storage drive 514, and external interface unit 520. The removable storage drive 514 interfaces with removable storage unit 518, such as a tape, a disk, or a memory stick. The external interface unit 520 may be connected to another removable storage unit 522. The processor 504 controls operations of the computer system 500 by executing computer-executable program code stored in a memory, e.g., a main memory 508, which can also be referred to as a computer-readable storage unit.

The present technology includes dividing a production facility into a plurality of zones and an energy consumption measuring device is installed in each zone. The energy consumed in each zone is measured and recorded. When it is desired to know which zone is not using energy efficiently, an analysis can be made for each zone using the energy usage data previously stored along with weather information (CDD and HDD) obtained from the weather-monitoring system, e.g., the local weather monitoring center, and also the past production data (number of units produced and total energy consumed). By using equation 2 or equation 3, the energy efficiency, or energy inefficiency, can be easily calculated. The system and method of the present invention are not applicable only the consumption of electrical energy but also to other types of energy such as natural gas, landfill gas, etc.

The memory, or computer-readable medium, may be a volatile medium, non-volatile medium, removable medium, or a non-removable medium. The term computer-readable media and variants thereof, as used in the specification and claims, refer to tangible or non-transitory, computer-readable storage devices.

In some embodiments, storage media includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

The computer-readable medium is part of the computing device also including the processor connected or connectable to the computer-readable medium by way of a communication link such as a computer bus.

The processor could be multiple processors, which could include distributed processors or parallel processors in a single machine or multiple machines. The processor can be used in supporting a virtual processing environment. The processor could include a state machine, application specific integrated circuit (ASIC), programmable gate array (PGA) including a Field PGA, or state machine. References herein to processor executing code or instructions to perform operations, acts, tasks, functions, steps, or the like, could include the processor 105 performing the operations directly and/or facilitating, directing, or cooperating with another device or component to perform the operations.

The computer-readable medium includes as mentioned computer-executable instructions, or code, which are executable by the processor to cause the processor, and thus the computing device, to perform any combination of the functions described in the present disclosure.

The present technology has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

For example, various aspects of the present technology can be implemented by software, firmware, hardware, or a combination thereof. After reading this description, it will become apparent to a person skilled in the relevant art how to implement the technology using other computer systems and/or computer architectures. Features described in different embodiments described in the present specification may be combined.

It is to be appreciated that the Detailed Description section, and not the Summary and Abstract sections, is intended to be used to interpret the claims. The Summary and Abstract sections may set forth one or more but not all exemplary embodiments of the present technology as contemplated by the inventor(s), and thus, are not intended to limit the present technology and the appended claims in any way.

What is claimed is:

1. A system, for calculating energy usage efficiency in a facility, comprising:
a processor; and
a first computer-readable memory having computer-executable program code that, when executed by the processor, causes the processor to perform operations comprising:
obtaining, from a secondary memory, past energy usage data;
obtaining, form the secondary memory, past production data;
obtaining from a weather-monitoring system, weather information;
estimating a plurality of variables based on the past energy usage data for a sliding time window; and
calculating the energy usage efficiency for the sliding time window.

2. The system of claim 1, wherein the weather information comprises cooling degree days and heating degree days.

3. The system of claim 1, wherein the production data comprises a number of units produced and a total amount of energy used.

4. The system of claim 1, wherein the calculating is performed according to an equation as follows:
Uᵢ=(Eᵢ/Yᵢ)−(β₀+β₁*HDDᵢ+β₂*HDDᵢ²+β₃*CDDᵢ+β₄*CDDᵢ²+β₅*Capacity_Utilizationᵢ+Vᵢ)
wherein,
Eᵢ=energy consumed in zone i,
Yᵢ=number of units produced in zone i,
HDDi=heating degree days,
CDDᵢ=cooling degree days,
Capacity_Utilization=variable representing alternative factors, such as production level,
β₀, β₁, β₂, β₃, β₄, β₅=variables derived using Stochastic Frontier Analysis,
Uᵢ=non-negative variable to account for energy inefficiency, and
Vᵢ=random variable.

5. The system of claim 1, wherein the facility is divided into multiple zones and the past energy usage data are for each zone.

6. The system of claim 5, wherein calculating further comprising:
calculating the energy usage efficiency for multiple sliding time windows for each zone; and
comparing calculated energy usage efficiencies from the multiple sliding time windows for each zone.

7. The system of claim 1, wherein the plurality of variables change their values when the sliding time window covers another time period.

8. The system of claim 1, wherein the operations further comprise:
measuring energy usage data, and
storing the energy usage data measured.

9. A method, for calculating energy usage efficiency in a facility, comprising:
obtaining, by a system using a processor, from a memory, past energy usage data;
obtaining, by the system, from the memory, past production data;
obtaining, by way of an external interface unit, from a weather-monitoring system, weather information;
estimating, by the system, a plurality of variables based on the past energy usage data for a sliding time window; and
calculating, by the system, the energy usage efficiency for the sliding time window.

10. The method of claim 9, wherein the weather information comprises cooling degree days and heating degree days.

11. The method of claim 9, wherein the production data comprises a number of units produced and a total amount of energy used.

12. The method of claim 9, wherein calculating is done according to an equation as follows:
Uᵢ=(Eᵢ/Yᵢ)−(β₀+β₁*HDDᵢ+β₂*HDDᵢ²+β₃*CDDᵢ+β₄*CDDᵢ²+β₅*Capacity_Utilizationᵢ+V₁)
wherein,
Eᵢ=energy consumed in zone i,
Yᵢ=number of units produced in zone i,
HDDi=heating degree days,
CDDᵢ=cooling degree days,
Capacity_Utilization=variable representing alternative factors, such as production level,
Uᵢ=non-negative variable to account for energy inefficiency, and
Vᵢ=random variable.

13. The method of claim 9, further comprising:
reading, by the system, energy usage data, and
storing, by the system, to the memory, the energy usage data.

14. The system of claim 9, wherein the plurality of variables change their values when the sliding time window covers another time period.

15. A tangible computer-readable storage device comprising computer-executable code that, when executed by a processor, causes the processor to perform operations, for calculating energy usage efficiency in a facility, comprising:
obtaining, from a memory, past energy usage data;
obtaining, from the memory, past production data;
obtaining, from a weather-monitoring system, weather information;
estimating a plurality of variables based on the past energy usage data for a sliding time window; and
calculating the energy usage efficiency.

16. The computer-readable storage device of claim 15, wherein the operations further comprise:
measuring energy usage data; and
storing the energy usage data.

17. The computer-readable storage device of claim 15, wherein the facility is divided into multiple zones and the past energy usage data are for each zone.

18. The computer-readable storage device of claim 17, wherein calculating further comprising:
calculating the energy usage efficiency for multiple sliding time windows for each zone; and
comparing calculated energy usage efficiencies from the multiple sliding time windows for each zone.

19. The computer-readable storage device of claim 15, wherein the weather information comprises cooling degree days and heating degree days.

20. The computer-readable storage device of claim 15, wherein calculating is done according to an equation as follows:
Uᵢ=(Eᵢ/Yᵢ)−(β₀+β₁*HDDᵢ+β₂*HDDᵢ²+β₃*CDDᵢ+β₄*CDDᵢ²+β₅*Capacity_Utilizationᵢ+Vᵢ)
wherein,
Eᵢ=energy consumed in zone i,
Yᵢ=number of units produced in zone i,
HDDi=heating degree days,
CDDᵢ=cooling degree days,
Capacity_Utilization=variable representing alternative factors, such as production level,
Uᵢ=non-negative variable to account for energy inefficiency, and
Vᵢ=random variable.
